(19) United States
(12) Patent Application Publication
(10) Pub. No.: US 2019/0149777 A1
(43) Pub. Date: May 16, 2019

(54) SYSTEM FOR RECORDING A SCENE BASED ON SCENE CONTENT

(71) Applicant: JUNGO CONNECTIVITY LTD., Netanya (IL)

(72) Inventor: OPHIR HERBST, HERZLIYA (IL)

(21) Appl. No.: 15/814,470

(22) Filed: Nov. 16, 2017

(51) Int. Cl. H04N 7/18; H04N 5/91; G11B 27/10

(52) U.S. Cl. CPC H04N 7/188; G06K 9/00832; G11B 27/10; H04N 5/91

(57) ABSTRACT

A system for monitoring a scene, including a processing unit in communication with an image sensor that obtains image data of the scene, a remote device, and a local storage device, where the processing unit records a portion of the image data and upon detection of an event, increases the portion of the image data being recorded.

### FIELD

The present invention relates to the field of monitoring and recording a scene, for example, a scene including a human operator, such as a driver.

### BACKGROUND

Human error has been cited as a primary cause or contributing factor in disasters and accidents in many and diverse industries and fields. For example, traffic accidents involving vehicles are often attributed to human error and are one of the leading causes of injury and death in many developed countries. Similarly, distraction (e.g., mental distraction) of a worker affects performance at work and is one of the causes of workplace accidents.

Therefore, monitoring and recoding scenes, which include human operators, such as workers or drivers of vehicles, is an important component of accident analysis and prevention.

In-vehicle cameras, for example, dash-cams, are used to record images of drivers inside vehicles or of the external view from the car. Typically, the information gathered by the camera is saved on a local memory card that can be removed from the camera and loaded onto a computer for off-line viewing. Typically, only a limited amount of information is stored on the memory card. This information is usually not uploaded to the cloud at all due to bandwidth limitations and large video file sizes.

In some cases, recording an entire scene, for liability and insurance purposes, may be required. For example, it may be required to record entire drives of autonomous vehicles, for passenger liability and insurance aspects. In other cases, for example, security purposes, efficient data recording is needed.

Real-time recording of drivers by using advanced mobile telecommunication technology, has been suggested. This technology requires using specific expensive devices and is, nonetheless, restricted by signal strength and transmission bandwidth.

Event activated sensors exist, mainly to save power consumption. These sensors typically only record an event itself, and not occurrences prior to or following the event, thereby providing only partial information of the scene.

No efficient solutions for real-time recording of vehicle operators or other apparatuses or scenes, exist to date.

### SUMMARY

Embodiments of the invention provide efficient recording of data (e.g., image data) from a location, thereby reducing required storage space and enabling to upload the recorded data to the cloud or other remote device.

In embodiments of the invention, predefined events in the location are automatically detected from the data collected from the location and data recording rates and/or resolution of recorded data are varied based on detection of the predefined event. This enables recording highly compressed variable time lapse and variable resolution data files that include the entire duration of a monitoring session, going into greater detail when an event occurs.

Embodiments of the invention enable to record less detailed data of a location when no event is detected and more detailed data of the event itself, thereby reducing the overall amount of data recorded without jeopardizing the recording and monitoring of actual events.

A system, according to one embodiment of the invention, includes a processing unit to receive data of a location and record a portion of the data. Upon detection of an event, the portion of the data being recorded is increased. Thus, the processing unit creates a detailed but compressed file of the location being monitored.

Because highly compressed files are created, according to embodiments of the invention, data from a plurality of processing units can be easily uploaded to a central processor (e.g., in the cloud) for big data analytics, to provide currently unavailable information, for example, regarding hidden patterns, unknown correlations, market trends, customer preferences, etc.

### BRIEF DESCRIPTION OF THE DRAWINGS

The invention will now be described in relation to certain examples and embodiments with reference to the following illustrative drawing figures so that it may be more fully understood. In the drawings:

FIG. 1 is a schematic illustration of a processing unit, according to an embodiment of the invention;

FIG. 2A is a schematic illustration of a processing unit operable in a system according to an embodiment of the invention;

FIG. 2B schematically shows amount of data in different portions as a function of time;

FIG. 2C is a schematic illustration of a processing unit operable in a system according to another embodiment of the invention;

FIG. 3 is a schematic illustration of a system for recording a scene, including a user device, operable according to embodiments of the invention;

FIG. 4 is a schematic illustration of a system for recording data from a location, including a buffer, operable according to embodiments of the invention;

FIG. 5 is a schematic illustration of a system for recording data from a location which includes an apparatus, according to an embodiment of the invention; and

FIG. 6 is a schematic illustration of a system for obtaining big data, according to embodiments of the invention.

### DETAILED DESCRIPTION

Embodiments of the invention provide systems and methods for automatic recording of information at a location and creating a compressed file of the recorded data, for easy monitoring of the location.

A location may include an in-door and/or out-door space being monitored by a sensor, such as an image sensor, radar or LIDAR (Light Detection and Ranging), audio sensor and/or other suitable sensors.

In one embodiment, a sensor is used to monitor a location which includes an operator of an apparatus, for example, a vehicle or other apparatus such as a computer, home or industrial equipment and healthcare equipment. For example, a location may include the inside of a cabin of a vehicle, including the driver of the vehicle and/or occupants other or in addition to the driver.

Typically, data (e.g., image data and/or audio data) of a location which is received from a sensor, is recorded and streamed for on-line monitoring and/or stored for off-line analysis. However, recording all of the data from the location may take up a great deal of memory storage space and/or bandwidth and may hamper saving and/or sending the data to remote devices. Thus, according to embodiments of the invention, only part of the data is recorded wherein the decision which part of the data to record is based on content of the data (e.g., visual content of a scene or sound content of audio data).

The content of the data may be detected by applying multiple algorithms. In one example, which is further detailed below, the content of an imaged scene may be detected using multiple methods, such as, object detection, motion detection, and applying other computer vision algorithms.

In one embodiment, the decision which portion of the data to record, is based on detecting a predefined event in the location. Predefined events may be automatically detected from the data collected from the location and data recording rates and/or resolution of recorded data are varied based detection of the predefined event.

An event in the location may be a pre-determined occurrence. In one example, an event is an occurrence which may indicate or lead to a potentially unsafe situation in the operation of an apparatus. In another example, an event includes a predetermined occupancy state of a monitored space (e.g., a number of passengers in a cabin of a vehicle compared to a predetermined threshold). Events may include other occurrences, according to embodiments of the invention.

In one embodiment the event may be determined based on parameters of the apparatus (such as speed or acceleration/deceleration, e.g., a sudden stop/break of a vehicle). In another embodiment an event may be determined based on occurrences or changes occurring in an imaged scene of the location. In other embodiments an event may be determined based on the state of the operator of the apparatus, as further exemplified below.

In one embodiment of the invention, image data or data of a scene, is collected from a location by an image sensor, the amount of data collected varying based on the contents of the scene. The variably collected image data and possibly additional data describing the scene (e.g. metadata) is recorded into a single, typically compressed, data file which may be viewed for on-line and/or off-line monitoring of the location.

For example, a data file of the scene (or location) may be sent to one or more remote devices that are accessible to remote users such as call centers, employers, owners of the apparatus, friends or family, who can monitor the scene substantially in real-time and call the operator and/or issue alarms to the operator and/or call for help if necessary.

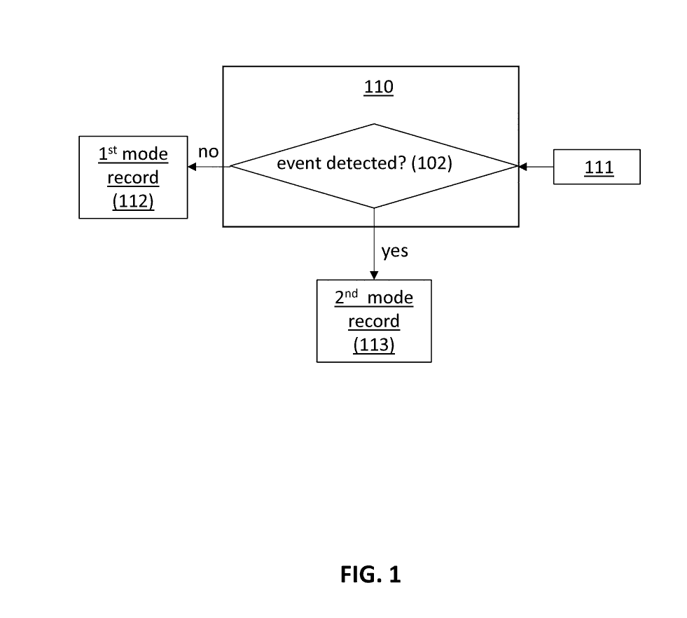

An example of a processing unit, according to embodiments of the invention, is schematically illustrated in FIG. 1.

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” “detecting”, “identifying”, “extracting” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

In the embodiment schematically illustrated in FIG. 1, processing unit 110 is part of a system for recording data of a location. Processing unit 110 is in communication with a sensor, e.g., imager 111, to receive data, e.g., image data of the scene at the location and to record a portion of the image data and, based on the content of the scene, change the portion of the image data that is recorded. In one embodiment, upon detection of an event, the portion of the image data being recorded, is increased.

In one example, the scene includes an apparatus or area of an apparatus, e.g., a vehicle or a cabin of the vehicle. In this example, an event may be a predetermined occurrence, e.g., in the cabin of the vehicle. An event may be, for example, an unsafe state of an operator of the apparatus, a medical condition of the operator, violence of a passenger, non-permitted occupancy of a vehicle cabin, change in number of occupants in the vehicle cabin, etc.

In one embodiment, image data from imager 111 is collected and recorded by the processing unit 110 in a first mode (112) and upon detection of an event (102) (e.g., a change in content of the scene and/or change in status of the apparatus) the image data from imager 111 is collected and recorded by the processing unit 110 in a second, different, mode (113).

Image data may include data such as values that represent the intensity of reflected light as well partial or full images or videos.

Imager 111 may include a CCD or CMOS or other appropriate chip. In some embodiments, the imager 111 includes a 2D or 3D camera. In one example, the imager 111 may include a standard camera provided with mobile devices such as smart phones or tablets. Thus, a mobile device such as a phone may be used to implement embodiments of the invention.

Processing unit 110 may include, for example, one or more processors and may be a central processing unit (CPU), a digital signal processor (DSP), a Graphical Processing Unit (GPU), a microprocessor, a controller, a chip, a microchip, an integrated circuit (IC), or any other suitable multi-purpose or specific processor or controller.

In some embodiments, processing unit 110 is a dedicated unit. In other embodiments, processing unit 110 may be part of an already existing apparatus multi-purpose processor, e.g., the processing unit 110 may be one core of a possibly multi-purpose, multi-core CPU already existing in an apparatus for doing other tasks.

In one embodiment, processing unit 110 is capable of detecting an event from the image data received from the imager 111 by applying image processing algorithms on the image data, such as known motion detection and shape detection algorithms and/or machine learning processes in combination with methods according to embodiments of the invention.

According to some embodiments the processing unit 110 includes or is in communication with a memory, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

In one embodiment the memory stores executable instructions that, when executed by the processing unit 110, facilitate performance of operations as follows:

Receiving data and recording the data in a first mode (112), e.g., recording a first portion of the data, for example, recording a certain percentage of the data and/or recording the data or part of the data at a certain resolution.

Upon detection of an event (102), recording the data at a second mode (113). For example, recording at a second mode may include, recording a different percentage of the data (e.g., higher or lower than the percentage in the first portion) and/or recording the data at a different resolution (e.g., higher or lower resolution than the resolution of the first portion).

The first and second portions of the data together include detailed data of the event and a reduced amount of data that is not of the event, thus providing a compressed data file that can be easily stored and/or transmitted.

Thus, if, for example, the first portion of data includes image data recorded at a first rate (e.g., 2 frames per second (fps)), the second portion, after detection of an event, may include image data recorded at a second rate (e.g., 30 fps or more), which is larger than the first rate, in order to achieve real-time imaging and avoid missing details of the event. In another example, the first portion of data includes image data saved at a first resolution and the second portion includes image data saved at a higher resolution than the first resolution.

In some embodiments part of the image data (e.g., specific objects such as an operator of an apparatus, other apparatuses (e.g., vehicles), objects external to the apparatus (e.g., pedestrians), etc.) is recorded at a higher resolution than the rest of the image data.

Although the examples herein describe image data collected by an image sensor, it should be appreciated that embodiments of the invention apply to other data, as well, such as audio data, using appropriate sensors, such as an audio sensor.

In some embodiments, processing unit 110 is in communication with a storage or other device to record the data to the storage or other device.

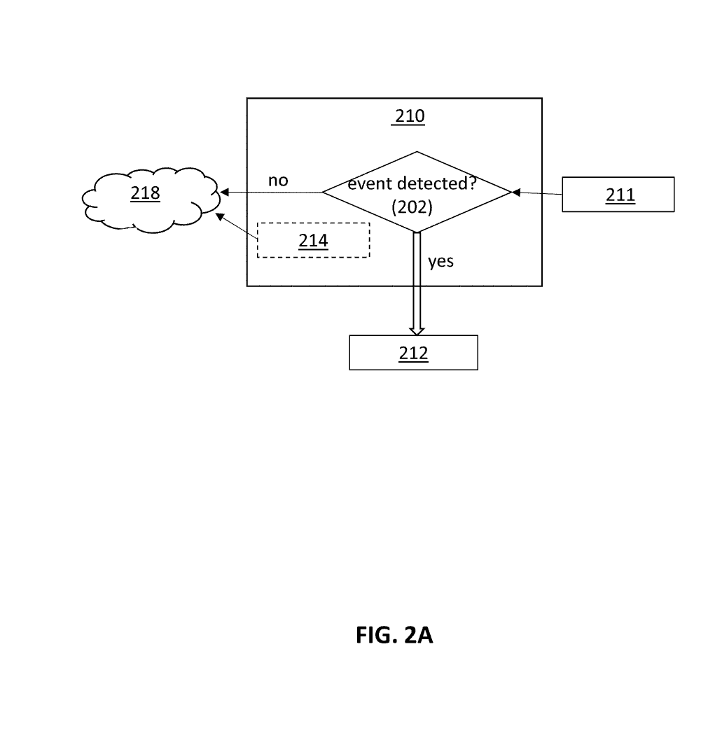

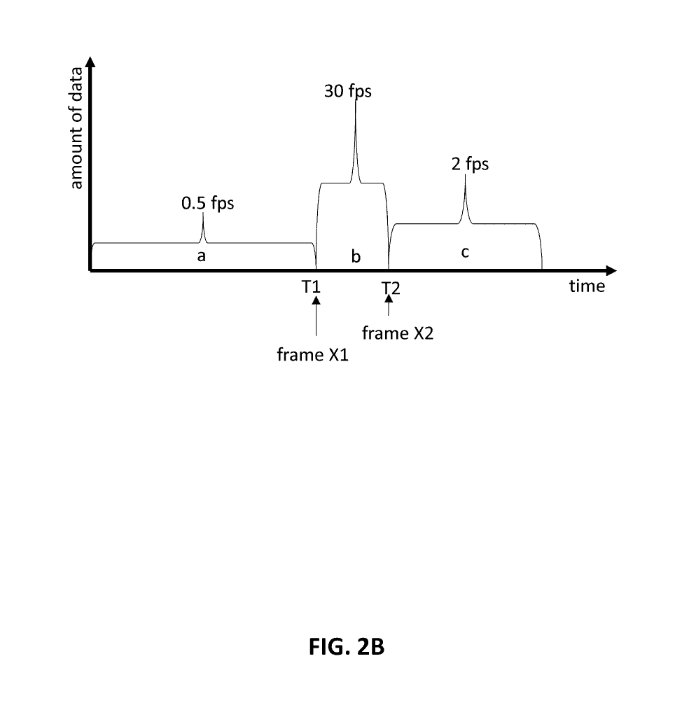

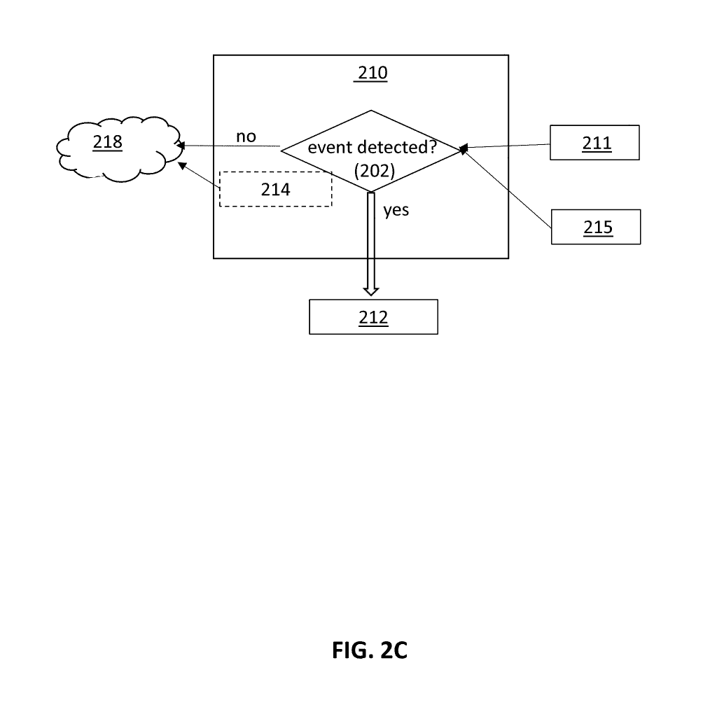

In one embodiment, which is schematically illustrated in FIG. 2A, a processing unit 210 is part of a system for recording a scene. The processing unit 210 is in communication with an image sensor 211 that obtains image data of the scene, a remote device 218, and a local storage device 212.

Processing unit 210 records, e.g., to local storage device 212 and/or to remote device 218, image data obtained from the image sensor 211.

Upon detection of an event (202) at processing unit 210, the mode of recording is changed and processor 210 starts recording the image data obtained from image sensor 211 in a different mode, typically a mode including recording an increased (as shown by the wide arrow), amount of the image data.

Processing unit 210 records the data in the first mode and the data in the second mode into a single data file and creates and stores metadata (214) of the data in the file.

According to one embodiment, the first mode of recording includes recording image frames at a first rate and the second mode of recording includes recording image frames at an increased rate.

In some embodiments the first mode of recording includes recording image data at a first resolution and the second mode of recording includes recording image data at a second resolution, the second resolution being higher than the first resolution. For example, part of the image data (e.g., specific objects in the scene) may be recorded at a second resolution, which is higher than the first resolution. Thus, processing unit 210 may apply object detection algorithms on the image data to detect specific objects (e.g., vehicles, people, etc.) and may then record the detected objects at a resolution that is different from the resolution of the rest of the image data.

In some embodiments, the images data recorded at the rates and/or resolutions are stored together, possibly with metadata (214), at local storage device 212, and may be later sent to the remote device 218.

The local storage device 212, which may be, for example, removable, internal, or external storage, may include, for example, a random access memory (RAM) device, a hard disk drive (HDD), solid state drive (SSD) and/or other suitable devices.

The remote device 218 may include, for example, a server in the cloud, an external control center, a user device and/or a database which is accessible to an external user.

In some embodiments, information or portions of the information sent by processing unit 210 are stored in an external database which is accessible to an external user so that the information in the database may be analyzed and used by the external user. For example, the external database may be configured to receive indications from an external user if the marking of image data, by processing unit 210, as being related to an event, is true or false. The indications may be used to update algorithms and processes at processing unit 210 to improve image analysis and detection processes.

In other embodiments, further described herein, data collected by processing unit 210 and its metadata (214) are sent to a processing center in the cloud for storage, monitoring and further analysis.

As schematically shown in FIG. 2B, a first portion (portion a) of data includes data recorded in a first mode of 0.5 fps. Although the data is recorded in the first mode for a long period of time (time is shown on the horizontal axis), the amount of data is typically small (amount of data is shown on the vertical axis) because the data is time lapsed (and/or resolution lapsed). Upon detection of an event at time T1 and at frame X1, the mode of recording is changed and data is recorded in a second mode at 30 fps. Thus, a larger amount of data (portion b) is recorded, even if the duration of the second mode of recording (which may correspond to the duration of the event) is not long. At time T2 (which may be at the end of the event) and at frame X2, the mode of recording is changed again to a third mode of recording, at 2 fps. This medium rate of recording produces a medium amount of data (portion c).

Correlating the frames X1 and X2 with the real-world times T1 and T2 may be done by using metadata (214) which may include, for example, a table mapping frames to real-world times. In addition to a time and frame map the metadata may include additional information, such as, GPS information, acceleration information and occupancy information. Additional information may be calculated from the metadata, such as, information relating to real-world times and locations and information about occupancy (e.g., number of people) at a location or a combination of information. Metadata (214), or information calculated from the metadata may also include information about object locations and resolutions, and various properties of the objects detected, sensor's unique ID, event information (e.g., duration of event, description of event, etc.), information regarding the state of the apparatus, etc. Thus, using metadata (214) enables easy search of specific events.

As described above, an event may be detected based on image processing of the image data received from the image sensor 211, however, in some embodiments, one example of which is schematically illustrated in FIG. 2C, an even is detected based on an external signal received at the processing unit 210.

In one embodiment processing unit 210 receives a signal indicating an event from an external device 215 and detects the event (202) based on the received signal.

In some embodiments device 215 includes a user operated device through which user input is translated to a signal indicating an event.

In other embodiments, the device 215 includes a sensor of an apparatus parameter such as an accelerometer and/or GPS and/or speedometer and/or other suitable measuring and sensing devices. A sensor of apparatus parameters may be an indicator of the apparatus operation. An indicator of apparatus operation provides indication that the apparatus is in operation. For example, an indication of apparatus operation may include one or a combination of an indication of motion (e.g., if the apparatus is a vehicle), an indication of key or button pressing (e.g., if the apparatus is operated by keyboard) and change in power status of the apparatus. In some embodiments the indicator of apparatus operation may be a user operated device into which the operator (or other user) may input an indication of apparatus operation. In other embodiments, the device 215 includes an external device, for example a car Controller Area Network (CAN) bus system, which may input an event such as a hard break of the car.

In one embodiment processing unit 210 records image data from the image sensor 211 only upon receiving indication from an indicator of apparatus operation. In other embodiments, processing unit 210 will switch from recording image data in a first mode to recording image data in a second mode only upon receiving an indication of apparatus operation and upon detecting an event.

In some embodiments, processing unit 210 applies motion detection algorithms on the image data obtained from image sensor 211 to receive indication of apparatus operation and/or to detect an event.

Communication between components such as processing unit 210, local storage device 212, remote device 218 and image sensor 211 may be through wired or wireless connection. For example, some components may include a suitable network hub.

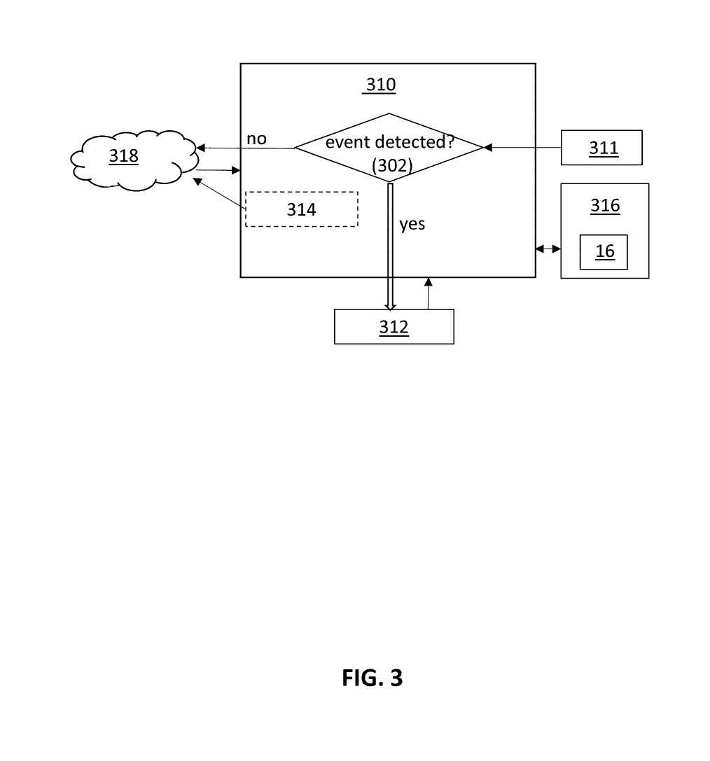

In one embodiment, the device 215 may be part of a user end device, as exemplified in FIG. 3.

In one embodiment, an example of which is schematically illustrated in FIG. 3, processing unit 310 records the image data obtained from the image sensor 311 in a first mode. Upon detection of an event (302), processing unit 310 starts recording the image data obtained from image sensor 311 in a second mode, typically a mode including recording an increased (as shown by the wide arrow) amount of image data. Processing unit 310 records the data in the first mode and the data in the second mode into a single data file and creates and stores metadata (314) of the data in the file.

Processing unit 310 is in communication with a user end device 316 that has a user interface 16. The user interface 16, typically including a screen or other display, may include buttons to enable a user to control the system (e.g., ON/OFF) and/or to enable the user to indicate to processing unit 310 that the apparatus is being operated and/or to enable other functions. Notices and other signals to the user may be displayed on the user interface 16.

In one embodiment user end device 316 may communicate, through processor 310, with local storage 312 and optionally with remote device 318, to obtain specific image data, based on the metadata (314) for example, based on a time and frame map.

The user end device 316 may be a stand-alone device or may be part of mobile devices such as smart phones or tablets.

In one embodiment, the user end device 316 is part of or is directly connected to the remote device 318 such that compressed movies or other compressed data files may be sent to the user end device 316 directly or through the cloud.

For example, the user end device 316 may be a driver input unit in a vehicle, operated by the driver via a user interface that can accept input from the driver and can send a signal to processing unit 310. When starting to drive the driver may use a button on the user interface to input relevant information such as date, time, location, vehicle or apparatus ID, imager ID, etc. and/or to indicate that the vehicle is being operated. While driving, the driver may use a button on the user interface to indicate an event (e.g., if the driver feels tired).

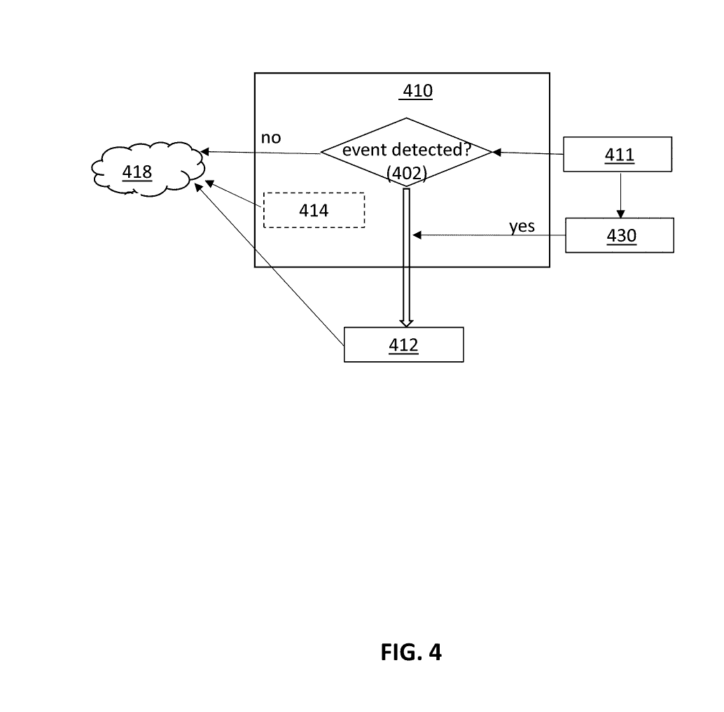

In one embodiment, which is schematically illustrated in FIG. 4, a system for recording a scene includes a buffer memory to maintain the image data.

In one embodiment, the processing unit 410 maintains a buffer memory 430 to which image data received from the imager 411 is saved. Upon detection of an event (402), processing unit 410 records the image data maintained in the buffer memory 430 to a storage device, e.g., the local storage 422 and/or to a remote device 418 and/or possibly directly to a user device (such as user device 316).

Typically, the image data is saved to the buffer memory 430 at a high rate (e.g., at 30 fps or more), e.g., at a rate similar to the rate at which image data is recorded after an event is detected. Thus, using buffer memory 430 enables to maintain image data collected prior to the event, making this data available together with data of the event, thereby providing detailed and full information of an event without needlessly taking up storage space.

The buffer memory 430 may maintain image data for a predetermined time. For example, the buffer memory 430 may be organized in a “first in, first out” method where image data (and possibly additional information, as described above) is maintained in the buffer until it is replaced with new data, dependent on the capacity of the buffer.

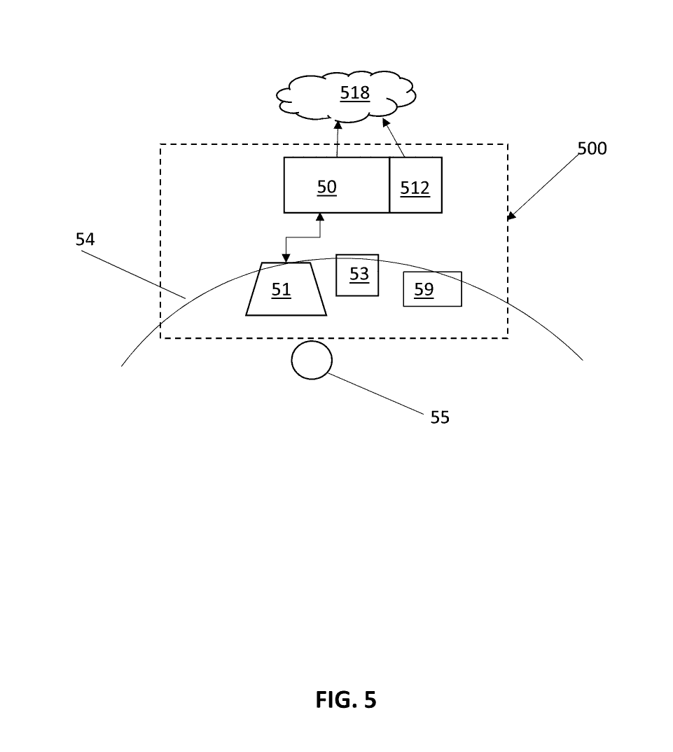

In an exemplary embodiment, which is schematically illustrated in FIG. 5, a processor and system according to embodiments of the invention, are demonstrated in connection with an apparatus (e.g., vehicle) and/or a person operating the apparatus (e.g., driver).

The system 500 includes a sensor, e.g., a camera 51 located or positioned to capture image data of a scene, which may include, for example, an area of an apparatus, typically also including the operator of the apparatus. In the example illustrated in FIG. 5, one or more camera(s) 51 may be positioned in a vehicle 54 so as to capture images of a driver 55 or at least part of the driver 55, for example, the driver's head or face and/or the driver's eyes. For example, camera 51 may be positioned on the windshield and/or on the sun visor of the vehicle and/or on the dashboard and/or on the A-pillar and/or in the instruments cluster and/or or on the front mirror of the vehicle and/or or on a steering wheel of a vehicle or front window of a vehicle such as a car, aircraft, ship, etc.

The terms “driver” and “driving” used in this description refer to any operator of an apparatus according to embodiments of the invention. The terms “driver” and “driving” may refer to an operator or operating of a vehicle (e.g., car, train, boat, airplane, etc.) or equipment or other apparatus. Although the following example describes a driver of a vehicle, embodiments of the invention may also be practiced on human operators of machines other than vehicles, such as computers, home or industrial equipment and healthcare equipment.

Camera 51 includes or is in communication with a processing unit 50. Processing unit 50 is capable of detecting an event from the image data received from camera 51 by applying a computer vision algorithm on the image data to detect the event.

Processing unit 50 receives image data from camera 51 and records a first portion of the image data (e.g., a certain percentage of the image data and/or a certain resolution). Upon detection of an event, the processing unit 50 starts recording a second, different, portion of the image data, (e.g., a higher or lower percentage of the image data and/or recording the image data at a higher or lower resolution than the resolution in the first portion). Processing unit 50 may send the first portion of image data and corresponding metadata to a remote device, such as to a device on cloud 518. The second portion is typically saved on a local storage device 512 and may be later sent to cloud 518.

In one embodiment processing unit 50 receives an indication of an event from an external sensor or device.

In another embodiment processing unit 50 applies computer vision algorithms (including, for example, computer vision, machine learning and deep learning processes) on the image data collected by camera 51 to detect the event. For example, an event may be detected based on detection of motion from the image data. Thus, motion of an operator and/or other people in the scene may cause the processing unit 50 to change the portion of image data that is recorded or the mode in which the image data is recorded. Similarly, lack of motion in the scene for a lengthy period of time may trigger another change in which an even smaller portion of the image data is recorded (e.g., recording at a very low rate). Thus, multiple algorithms may be used to cause processing unit 50 to record image data in multiple modes.

In another example, an unsafe state of the operator (e.g., driver 55) or a change in the operator's state is detected from the image data.

An operator's state refers mainly to the level of distraction of the operator. Distraction may be caused by external events such as noise or occurrences in or outside the space where the operator is operating (e.g., a vehicle), and/or by the physiological or psychological condition of the operator, such as illness, drowsiness, fatigue, anxiety, sobriety, inattentive blindness, readiness to take control of the apparatus, etc. Thus, an operator's state may be an indication of the physiological and/or psychological condition of the operator.

An unsafe state of an operator (e.g., driver or other operator or person) refers to an operator's state leading to a possible event, such as a health risk event or an event that could be detrimental to the operation of a vehicle or other machine. For example, a distracted (e.g., drowsy or anxious) state of a driver is typically an unsafe state of the driver. In another example, a distracted or otherwise not normal state of a person (e.g., above normal eye blinks, etc.) may indicate an undesirable psychological event or an imminent health risk event such as a stroke or heart attack and is considered an unsafe state of a person in a monitored scene.

In one embodiment processing unit 50 detects the event based on biometric parameters of a person in the scene. In one embodiment, processing unit 50 applies image processing algorithms to detect, from the image data, a part of the operator, such as driver 55. In one example, face detection and/or eye detection algorithms may be used to detect the driver's head and/or face and/or features of the face (such as eyes) from the image data. In some embodiments a computer vision algorithm is applied on the image data to detect biometric parameters of the driver 55 and to detect an unsafe state of the driver 55 based on the detected biometric parameters.

Biometric parameters extracted from image data of the driver, typically by using computer vision techniques, include parameters indicative of the driver's state, such as, one or more eye gaze direction, pupil diameter, head rotation, blink frequency, blink length, mouth area size, mouth shape, percentage of eyelid closed (perclos), location of head, head movements and pose of the driver.

Tracking an operator's head or face, e.g., to detect head and/or eye movement, may be done by applying optical flow methods, histogram of gradients, deep neural networks or other appropriate detection and tracking methods.

Parameters such as direction of gaze or posture or position of a driver's head may be determined by applying appropriate algorithms (and/or combination of algorithms) on image data obtained from camera 51, such as motion detection algorithms, color detection algorithms, detection of landmarks, 3D alignment, gradient detection, support vector machine, color channel separation and calculations, frequency domain algorithms and shape detection algorithms.

In some embodiments processing unit 50 (or another processor) may be used to identify the driver 55 in images obtained from the camera 51 and to associate the identified driver to a specific set of biometric parameter values.

Processing unit 50 may track a driver's head or face in a set of images obtained from camera 51 and extract biometric parameter values of the driver based on the tracking. In one embodiment biometric parameter values of a specific driver obtained from a first set of images are used to represent the baseline or normal state of the driver and may thus be used as a reference frame for biometric parameter values of that same driver obtained from a second, later, set of images.

In some embodiments the system 500 includes or is in communication with one or more sensors to sense operation parameters of the apparatus, which include characteristics typical of the apparatus. For example, motion sensor 59 may sense motion and/or direction and/or acceleration and/or location (e.g., GPS information) and/or other relevant operation parameters of the vehicle 54 thereby providing a signal indicating that the apparatus is being operated.

In one embodiment image data is recorded or collected by processing unit 50 based on a signal from a sensor of operation parameters of the apparatus, such as motion sensor 59. In some embodiments a second, typically increased portion of the image data is recorded based on a signal from sensor 59.

In some embodiments, the portion of image data recorded is changed based on processing unit 50 receiving indication that the apparatus is in operation and based on detection of an event. In one example, indication is received from motion sensor 59 that the vehicle 54 is in operation, for example, if the vehicle is moving above a predetermined speed for above a predetermined time and in a predetermined direction.

In addition to changing the mode of recording data, a command generated by processing unit 50, based on detection of an event, may include an alarm to alert the driver and/or a signal to control a device or system associated with the vehicle such as a collision warning/avoiding system and/or infotainment system associated with the vehicle 54. In another embodiment, the command may be used to send a notification to an external control center.

In some embodiments the system 500 includes one or more illumination sources 53 such as an infra-red (IR) illumination source, to facilitate imaging (e.g., to enable obtaining image data of the driver even in low lighting conditions, e.g., at night).

All or some of the units of system 500, such as camera 51 and/or motion sensor 59 may be part of a standard multi-purpose computer or mobile device such as a smart phone or tablet.

Embodiments of the invention offer an efficient and affordable way of providing detailed and full information for on-line monitoring and off-line analysis of a scene.

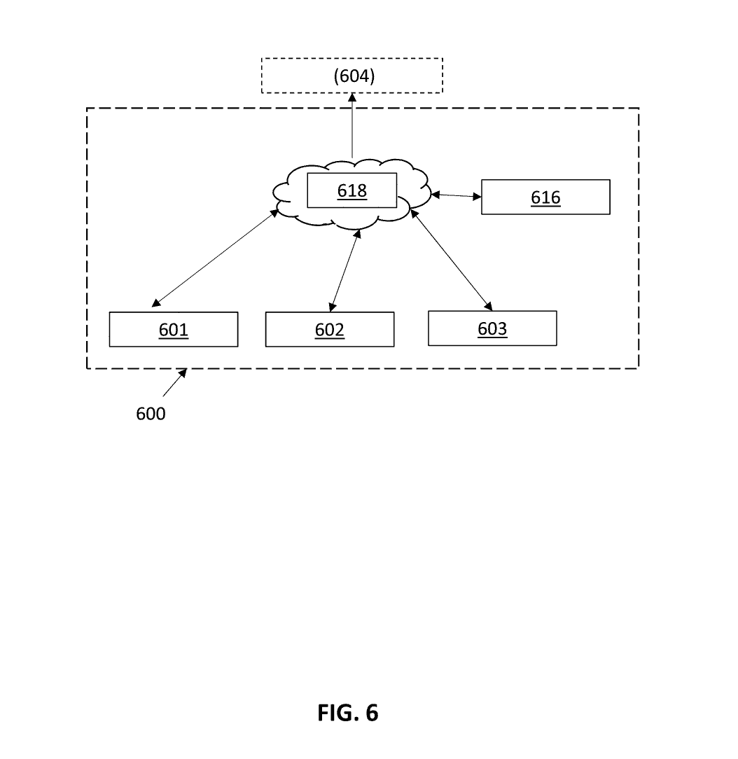

In one embodiment, an example of which is schematically illustrated in FIG. 6, a system 600 includes a central processor 618 in communication, typically over the internet or other suitable wireless communications network, with a plurality of sensors 601, 602 and 603. The central processor 618 may be, for example, part of a server located in the cloud.

Each of sensors 601, 602 and 603 may create a data file which includes image data recorded in a first mode and image data of an event, recorded in a second mode (e.g., as described herein). Additionally each of sensors 601, 602 and 603 create metadata corresponding to the recorded image data and to the event, for example, as described herein. In this example, the sensors are typically image sensors, however, other sensors may be used, according to embodiments of the invention, to record data from a location, other than or in addition to image data.

Each sensor sends the data file and the corresponding metadata to the central processor 618. In some embodiments only the metadata and/or part of the data file are sent to the central processor 618.

The system may further include at least one user end device 616 in communication with the central processor 618 to receive one or more data files upon demand.

The user end device 616 typically includes a user interface and a display, such as a screen or monitor, to display the image data. The user interface can accept a user demand to receive from the central processor 618 a part of the recorded image data. For example, a user viewing a time lapsed movie recorded by a sensor (e.g., one of sensors 601, 602 or 603) in which an event is shown, may ask to see the more detailed movie of the event which may be saved locally at the sensor. The user may request the more detailed movie through the user interface of the user end device 616. The request, typically processed by central processor 618, may then be sent to the local storage at the sensor to obtain the more detailed movie. The more detailed movie may be retrieved by using the metadata, e.g., by specifying, through the user end device 616, a real-world time and/or real-world location and receiving the parts of data corresponding to the specified time and/or location.

In some embodiments the user end device 616 receives a data file and the metadata corresponding to the data file, and displays the data file together with information calculated from the metadata. For example, the information calculated from the metadata may include one or more of: real-world time, location information, event description and occupancy information. Thus, in one example, a movie created according to embodiments of the invention may be displayed with a running time line (or other icon tracking time) of the actual time of each frame shown in the movie and/or with an icon or text describing each event as it is shown in the movie and/or other descriptions of the movie, calculated from the metadata.

In one embodiment, the central processor 618 saves all data files sent to it and can maintain the files chronologically and/or in any desired sequence or arrangement based on the metadata. Thus, extensive and uninterrupted records of a location or of an operator of apparatus may be kept available, for example, for later restoration and analysis.

In one embodiment the central processor 618 can generate analytics 604 based on the metadata received from the plurality of sensors 601, 602 and 603. For example, types of events and/or number of events can be linked to geographical areas, or types of operators, to uncover hidden patterns and unknown correlations. Analytics 604 may be displayed to a user, for example on a display of user end device 616, to enable system users to make informed decisions.

What is claimed is:

1. A system for recording a scene, the system comprising:
a processing unit in communication with
an image sensor that obtains image data of the scene, and
a storage device,
the processing unit configured to
receive the image data,
record the image data to a data file at the storage device in a first mode, and
upon detection of an event, record the image data to the data file in a second mode.

2. The system of claim 1 wherein the processing unit is to create and store metadata of the image data in the data file.

3. The system of claim 2 comprising a user end device in communication with the processing unit, said user end device to obtain from the storage device, specific image data, based on the metadata.

4. The system of claim 1 wherein the processing unit is to apply a computer vision algorithm on the image data to detect the event.

5. The system of claim 4 wherein the processing unit is to detect the event based on biometric parameters of a person in the scene.

6. The system of claim 4 wherein the processing unit is to detect the event based on motion detected in the scene.

7. The system of claim 1 wherein the processing unit is to receive a signal indicating the event and detect the event based on the signal.

8. The system of claim 1 wherein the first mode comprises recording image frames at a first rate and the second mode data comprises recording image frames at a second rate, the second rate being higher than the first rate.

9. The system of claim 1 wherein the first mode comprises recording image data at a first resolution and the second mode comprises recording image data at a second resolution, the second resolution being higher than the first resolution.

10. The system of claim 1 comprising a buffer memory to maintain the image data and wherein the processing unit is to record the image data from the buffer memory to the storage device, upon detection of the event.

11. The system of claim 2 wherein the metadata comprises one or a combination of: time/frame map, GPS information, acceleration information and occupancy information.

12. The system of claim 1 wherein the scene includes an apparatus.

13. The system of claim 12 wherein the processing unit is part of an already existing multi-purpose processor of the apparatus.

14. The system of claim 12 comprising an indicator of apparatus operation, the indicator in communication with the processing unit to provide indication that the apparatus is in operation.

15. The system of claim 14 wherein the processing unit is to record the image data at the second mode upon receiving the indication from the indicator.

16. The system of claim 1 wherein the image sensor is part of a multi-purpose mobile device.

17. A system comprising:
a central processor;
a plurality of sensors, each sensor in communication with the central processor and each sensor configured to
create a data file comprised of image data recorded in a first mode and image data of an event, recorded in a second mode;
create metadata corresponding to the recorded image data and to the event, and
send to the central processor the data file and the metadata.

18. The system of claim 17 comprising a user end device in communication with the central processor, the user end device configured to
receive a data file and the metadata corresponding to the data file, and
to display the data file together with information calculated from the metadata.

19. The system of claim 18 wherein the information calculated from the metadata comprises one or more of: real-world time, location information, event description and occupancy information.

20. The system of claim 17 wherein the central processor is configured to generate analytics based on the metadata received from the plurality of sensors.
